(19) United States
(12) Patent Application Publication
(10) Pub. No.: US 2012/0331269 A1
(43) Pub. Date: Dec. 27, 2012

(54) Geodesic Massively Parallel Computer.

(76) Inventor: Richard John Edward Aras, London (GB)

(21) Appl. No.: 13/518,889

(22) PCT Filed: Dec. 24, 2010
(86) PCT No.: PCT/GB2010/002338

§ 371 Date: Sep. 4, 2012

(30) Foreign Application Priority Data
Dec. 24, 2009 (GB) 0922562.4

(51) Int. Cl. G06F 15/76

(52) U.S. Cl. 712/29; 712/E09.002

(57) ABSTRACT

Communication latency, now a dominant factor in computer performance, makes physical size, density, and interconnect proximity crucial system design considerations. The present invention addresses consequential supercomputing hardware challenges: spatial packing, communication topology, and thermal management. A massively-parallel computer with dense, spherically framed, geodesic processor arrangement is described. As a mimic of the problem domain, it is particularly apt for climate modelling. However, the invention's methods scale well, are largely independent of processor technology, and apply to a wide range of computing tasks. The computer's interconnect features globally short, highly regular, and tightly matched distances. Communication modes supported include neighbour-to-neighbour messaging on a spherical-shell lattice, and a radial network for system-synchronous clocking, broadcast, packet-switched networking, and IO. A near-isothermal cooling system, physically divorcing heat source and sink, enables extraordinarily compact geodes with lower temperature operation, higher speed, and lower power consumption.

### BACKGROUND OF INVENTION

1. Field of the Invention

Massively parallel computer systems for climate modelling and other high-performance computing applications.

2. Problem Statement

The prospect of global warming propels climate science centre stage and with it the “grand challenge” computational problems on which climate modelling relies. It is widely acknowledged that computer performance on a vastly grander scale will be necessary to significantly improve predictions and gain deeper insight into the ecosystem. Climate modelling is described as an “embarrassingly parallel” computing problem with effectively no upper bound to the computing performance or number of processors (parallelism) that can be usefully thrown at it. However, building computers many orders of magnitude faster and more parallel poses huge technical challenges.

As more parallelism is utilized, supercomputers are getting physically larger, some now occupying hundreds of square metres of floor space. As semiconductor logic gets faster (clock scaling), communication latency between processors becomes an increasingly significant and limiting overhead. Already, the limits of systems' execution efficiency and performance have become dominated by latency rather than logic speed. At all levels of the design hierarchy, from transistor to software module, temporal delays in moving data around between subunits, processors, or processes critically affects performance and design. Indeed, vast tracts of modern microprocessor real estate are given over to mitigating the “memory wall”—the dominance of main memory access time over processor cycle time. As parallel computers get larger and faster the memory wall becomes an inter-process latency wall: time of flight for communications will completely dominate cycle and memory access times.

Climate modelling (a cogent example of chaotic processes that have no analytical solution) invariably uses numerical finite-element modelling techniques where elements on a 3D grid or lattice represents physical parameters or material state of a parcel of ocean, land or atmosphere. Sequential algorithm steps depend on prior states within a small neighbourhood of interacting elements. Processors are assigned to elements and repeatedly communicate their dynamic state to logical neighbours. Algorithms of this type may be simple and each step be processed very rapidly. As technology advances, iteration periods on the order of nanoseconds can reasonably be anticipated in the near future. With possibly millions of processors, this scenario requires (or is limited by) extraordinarily fast and copious inter-element, inter-processor communication. Nanosecond latency demands maximum interconnect distances on the order of centimetres as determined ultimately by the speed of light. Hence, it is advantageous to pack processors into as small a volume as possible. Due to the essentially two-dimensional (2D), planar nature of common lithographic manufacturing processes, this translates effectively into maximising active computing surface area per unit volume.

Performance (especially parallel execution) is generally determined by worst case signal delay not average latency—the whole machine waits for the last straggling message to be delivered before continuing. Clearly, a sprawling supercomputer with signals travelling tens of metres and message latencies measured in microseconds will not cut the mustard. While general-purpose communication networks are preferable in terms of flexibility and cost, latency factors mean that any interconnect network that does not closely match the application domain topology will be burdened by bottlenecks and inefficiency. Note that the earth's climate, and ecosystem is not a solid sphere, but instead an extremely thin layer or spherical shell.

Another crucial issue for large computer systems is synchronization. At the chip level this is manifest in clock distribution and timing skew. And up through the system hierarchy at all levels, signalling tends to resort to asynchronous techniques. Latency is added where resynchronization is required in crossing clock domains or synchronization boundaries. Handshaking (flow control) and non-deterministic communication protocols then multiply resynchronization penalties. Each resynchronization stage necessitates extra memory, data buffering, registers or FIFOs, with negative implications for build costs, power consumption, and performance. Resynchronization also incurs a finite risk of data errors through metastability. Again, as systems get larger and more distributed, all such effects and difficulties are compounded and exacerbated. Indeed, tight control over system timing is always judicious, but lowest-level synchronization (clocking) is a requisite foundation for processes to be optimally scheduled and run efficiently in lockstep. To those skilled in the art, this argument should seem obvious or virtually tautological. However, this property (lower-level global synchronization) is notably absent from all but the tiniest systems. Modern supercomputers and even microprocessors instead utilize many, many clock domains and synchronization layers.

High-performance computer systems consume large amounts of electrical power which gets dissipated as heat. Typically, a similar amount of energy is used by refrigeration systems as the computer proper, so adding considerably to already high running costs. This is despite the fact that their processors and other active components operate on a temperature gradient well above ambient—a situation analogous to pushing water downhill. The second law of thermodynamics dictates rapidly increasing heatpump power consumption as the temperature differential increases between heat source and sink: it is hugely beneficial to minimise temperature gradients and thermal resistances where the operating temperature is anywhere close to the ambient coolant temperature. Using air as a heat transport medium is a poor choice. Not only is refrigeration energy wasted, but this inefficiency belies running circuits colder, faster, with less power, and with fewer reliability issues. (Cooler computer chips show dramatically improved speed-power ratios.) The corollary to this is that utilising a colder sink such as a glacial river or lake water can lead to significant power savings—primarily due to enabling circuit operation at lower supply voltages.

The heatsinks in contemporary processors have very much larger bulk than the active devices they cool. Furthermore, heatsinks typically require significant additional space around them for the ducting of cooling fluid, commonly air. As the cooling fluid passes over several devices, the first are cooled more than the last. The distribution of heat produced within chips or systems is also very uneven. Hotspots so created eat into design margins and reduce the overall performance attainable. Clearly, effective cooling is a challenge aggravated by larger machines requiring higher packing densities.

In summary, three interrelated problems need solving simultaneously: volumetric packing, communications performance, and thermal management. What is needed is a massively parallel computer for climate modelling with millions of highly-interconnected, well synchronized processors, specifically organized to suit the problem domain, crammed into a small space, and with greatly improved heat extraction.

### PRIOR ART

The history of parallel computing stretches back more than half a century and is marked by many notable contributions such as IBM's Blue Gene, Japan's ESC's Earth Simulator and RIKEN MDGRAPE-3, Thinking Machines' Connection Machine, Goodyear MPP, and so forth. Silicon processor chips have also been designed for—or extensively use—parallel execution. For instance InMos' Transputer, and modern graphics processor chips from the likes of ATI and NVIDEA.

Characterised by their style of processing (MIMD, SIMD, dataflow, et cetera) and by their interprocessor interconnect topology and technology, almost all share similar packaging, construction, and connectivity implementation hierarchy. That is: assemble components (chips) onto boards, boards into racks, racks into cabinets, cabinets into rooms. Communication channels typically consist of printed wiring on circuit boards and backplanes, with electrical and fibre optic cabling running over longer distances. Modern processor-clusters' communication in and between cabinets of massively parallel systems is typically cabled, packet switched networks such as Infiniband or Ethernet.

In such systems there is an orthogonal three-dimensional (3D) array packing of processors, but generally this physical arrangement of processors does not match closely the inter-processor interconnect topology. Nor do the these physical topologies (often star, ring or torus) correspond closely with the application domain since preference is given to supposedly general-purpose networks. Higher-order hypercube topology, for instance, has no direct physical analogue in three-space. Hence latency and bandwidth is not entirely homogeneous across processor interconnect. Communication speed is also orders of magnitude lower than processor load-store bandwidth or processor-memory bandwidth, especially over worst-case routes.

Connection and communication topologies have traditionally included star, ring, mesh, torus, hypercube, Banyan tree, and many other variants. Homogeneous, spherical mesh topologies suited to finite-element climate modelling are apparently unprecedented in hardware or physical instantiations. However, geodesic meshes for climate modelling were suggested as early as 1968 by Sadourny, R. A., Arakawa, and A. & Mintz. Further implementations in software have more recently been described in “Domain Decomposition: Using Massively Parallel Architectures” by David Randall at Colorado State University, in 2001. Randall also describes mapping patches of the geode mesh onto a more traditional orthogonal grid.

Most machines have followed rectilinear designs, but exception do exist. Early Cray supercomputers (not classed as highly parallel machines) had a segmented-cylindrical arrangement of circuit board racks in order to minimise signal delays and optimise cooling.

For nearly thirty years wafer-scale computers have been discussed and proposed due largely to the lower cost and ease of implementing very high performance interconnect in contrast to package chips.

Thermal management of computers historically has used combinations of forced air, heat exchange liquid circulation, phase-change refrigeration, heat pipes and other techniques. Complete submersion in cryogenic liquids has also been suggested for some processor technologies, particularly superconducting and quantum computers. Two-phase, liquid-vapour systems have been shown to be effective in many variations. U.S. Ser. No. 16/510,422 describes capillary action heat pipes, and U.S. Pat. No. 6,948,556 U.S. Pat. No. 6,990,816 hybrid cooling devices, for example.

### DESCRIPTION OF THE INVENTION

### Summary of Invention

The present invention provides methods for massively-parallel computer implementation in which processing elements are spatially packed in a spherical, geodesic arrangement as depicted in FIG. 1. In contrast to conventional orthogonal 2D or 3D computer arrays without any direct geodesic mapping or central void, the present invention implements a spherical, hollow shell. Form fits function: the arrangement is an excellent analogue of the earth's ecosphere. The invention enables a very large number of processors to operate with greatly reduced interconnect distance thereby achieving lower communication latencies and high performance. Two basic physical topologies, or modalities of communication, are supported: annular mesh within the sphere's shell, and radial communication from or through the centroid of the sphere.

For concentric communication flows around the sphere, best and worst-case neighbour-to-neighbour distances are short and similar. Given this proximity, very large numbers of signals can be routed easily and cheaply between adjacent subunits facilitating bandwidths and latency not dissimilar to those achievable between processors on a single board, wafer or chip. The 2D mesh or layered 3D spherical lattice so constructed is particularly apt for finite-element climate modelling algorithms.

Being a practically homogeneous surface of constant radius, all processors may operate in tight synchrony from a single clock source or timing reference emanating from the sphere's centre as in FIG. 5. This radial modality of communication also facilitates broadcast of data or instructions with high performance and substantially equal, deterministic timing. Radial transmission also provides a one-hop, any-to-any shortcut with an a connection distance of exactly one diameter. The radial modality is apt for non-mesh, dynamically routed and packet switched data. The geode may house network switches, clock and other infrastructure in the central void space (the “centroid”).

Further improvements decimate the radius by stacking and folding of the active 2D surfaces (e.g. wafer-scale silicon processors) creating enhanced density, gyrencephalic packings. Clusters of processors in this waffle-style arrangement, FIGS. 6 and 7, may constitute a standardized plug-in subunit with advantages for manufacturing, installation, maintenance, and scaling system configurations. A robotic repair and reconfiguration system, FIG. 5, automates the rapid swap out of such subunits in an operating environment inhospitable to human operatives, and where mean-time-to-failure could be short.

The thermal management method presented here provides efficient, near-isothermal cooling utilizing a phase-change refrigerant in intimate contact with processors and other power-dissipating components. Wetted components are cooled as the refrigerant evaporates into a large, isobaric pressure chamber housing the whole computer geode. The wetted surface is provided with a porous wicking layer which adds little to the volume of the device being cooled. By design, vapour is kept saturated and flows are within the “non-compressible” thermodynamic regime. Hence, a stable chamber pressure dictates boiling point, liquid-phase temperature, and therefore sets the temperature maintained throughout (similar to the operating principle of conventional heatpipe loops). It is well known that evaporative cooling can achieve extraordinary heat flux density. Vapour is ducted to heat exchangers, possibly via compressors, where it is cooled, condensed, and returned to the geode as a liquid.

Input-output (IO), power distribution, mass storage and human-interface apparatus complete the computing system in normal ways. Mass storage units, such as disk drive arrays, would be housed separately and connected to the geode via, for example, fibre optic bundles. A variety of IO communication methods are provided with data fed through conduits in the geode body, and/or with free-space optical communication.

Climate modelling is not unique in its computational requirements, but it does serve as a topical and critical example of technical issues facing high performance computing (HPC). While a shell-mesh topology serves climate models well, it will be noted that many alternate interconnect topologies could be supported using the same machine including 2D and 3D orthogonal mesh, torus, isometric mesh and so forth, possibly using a subset of processors or sections of the geode. In every sense, the present invention is as general purpose as other parallel computers and is eminently scalable in terms of size, configuration and performance. It lends itself well to a broad variety of Grand Challenge problems such as protein folding, computational chemistry, and fluid dynamics, as well as serving more mundane tasks such as web search engines, or computer graphics visualisation.

Where a spherical topology is unnecessary (such as a Internet application server perhaps), the geode may be opened up into a tubular or hemispherical form, thereby substantially easing some design constraints whilst maintaining most advantages. For instance, given the ready accessibility (compared to a full sphere) of both inner and outer surfaces, refrigerant may now be deployed in both or just one of the corresponding spaces. Of particular note is that refrigerant can be contained on one side while the other is open to the atmosphere. Furthermore, processor modules in this configuration may use indirect cooling through contact with a heatsink which itself is refrigerant cooled so potentially obviating airlocks and material compatibility constraints between module and refrigerant. Such modifications and variations are considered to be within the scope of the current invention.

### BRIEF DESCRIPTION OF DRAWINGS

FIG. 1: Spherical parallel computer system with geodesic processor arrangement.

A building, 106, housing a parallel computer, 100, comprised of a geodesic arrangement of processor clusters, 107, in a spherical mimic of the earth. An atmosphere of pure refrigerant vapour is contained by a pressure vessel, 102, enveloping the computer globe or geode, 100, which is cooled by evaporation of liquid refrigerant directly from its active surfaces. Ducts, 103, convey refrigerant vapour to compressors, 104, that maintain a constant pressure (an isobaric atmosphere) and thereby preserve substantially isothermal computer operation. Heat exchangers, 105, exhaust heat to ambient thermal sinks (usually air or water), reliquefying refrigerant for return to the computer, 100, using pumps. A person illustrates relative size for a prospective silicon-based computer, though the construction principle may scale to any other size appropriate to the underlying processor technology.

FIG. 2: Derivation of geodesic facetted surfaces from polyhedra showing distortions.

A sequence of increasingly subdivided, triangle-facetted, geodesic surfaces derived from icosahedron, 201, and cube, 202. The subdivisions in this example yield four times the number of triangles in each generation which on the icosahedron (at the left) are identical equilaterals. However, note that distortions in the regularity of facets result from projection onto a sphere (right), and substantially more so for the cube than the highest-order Platonic solid.

FIG. 3: Geode with rhombic subunit illustrating repetition frames and centroid.

An icosahedral geode, 300, with paired triangles used as the basis for tessellating identical rhombic subunits, 301, on the sphere. The original twenty faces are illustrated by dashed lines. A thickened unit of supporting framework with rhombic prism cut-outs, 302, forms a segment in the computer geode and a unit of repetition in the design and manufacturing hierarchy. Ten such segments comprise the complete geode. These, depicted from the inside, 303, and outside 304, make apparent the slightly irregular distribution. The framework, 305, houses identical processor cluster units, 107, at equal radius from the geode centroid, 307, which forms a centralized connection zone for signals conveyed by cables, 306.

FIG. 4: Computer detail with robot arm and pressure vessel housing.

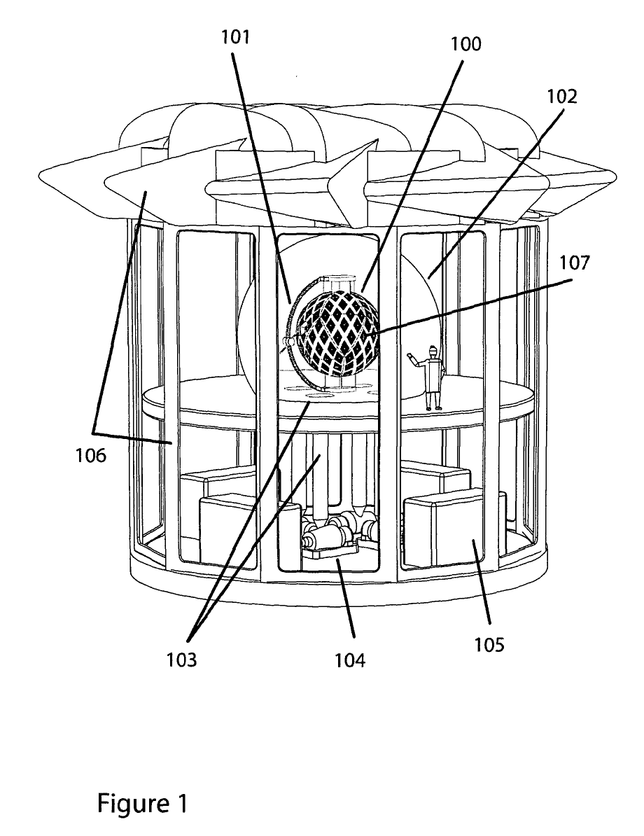

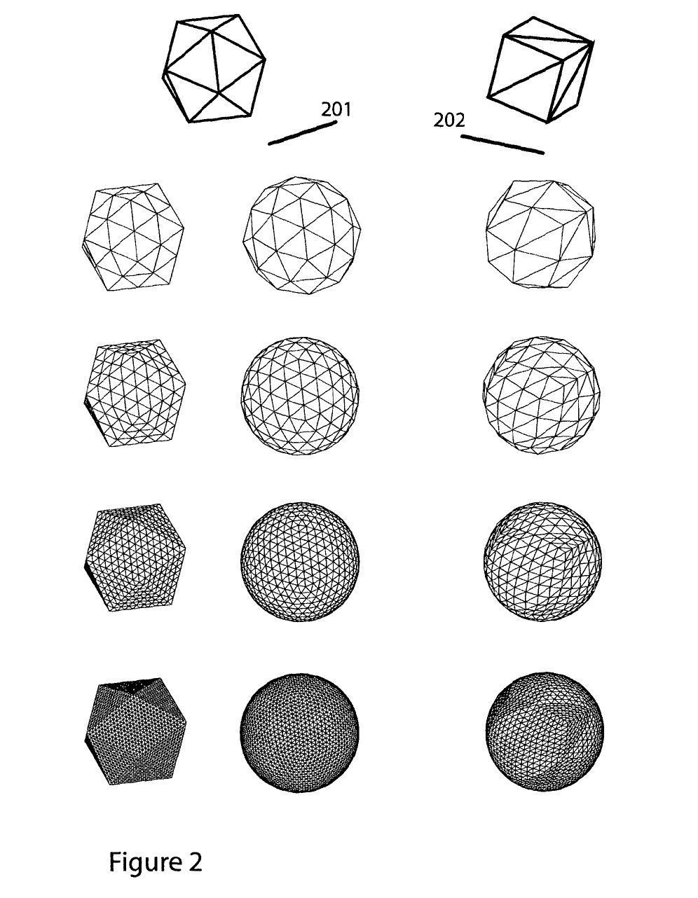

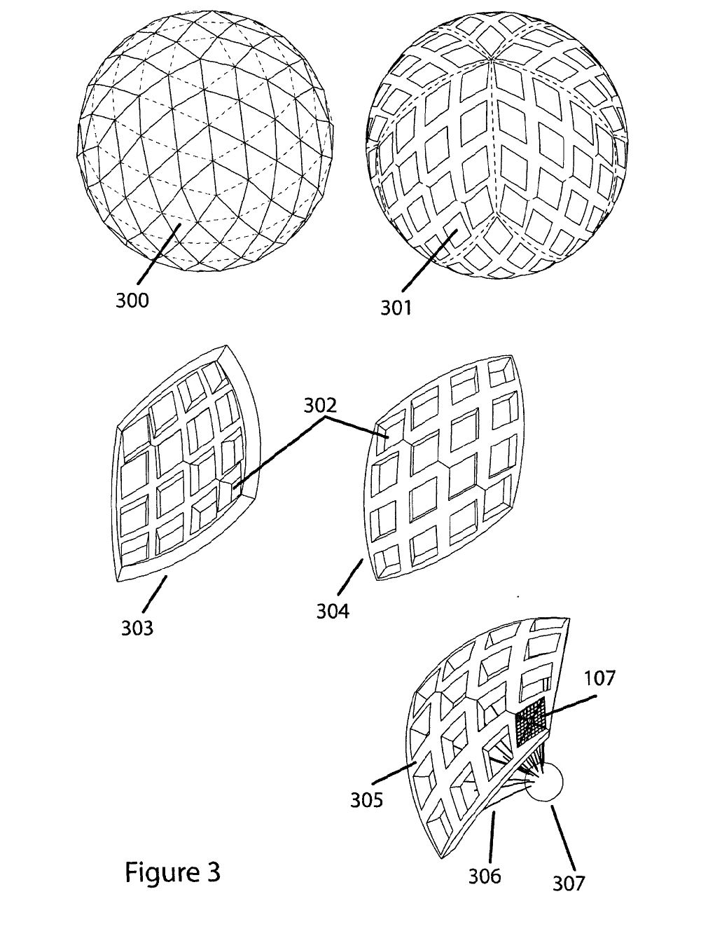

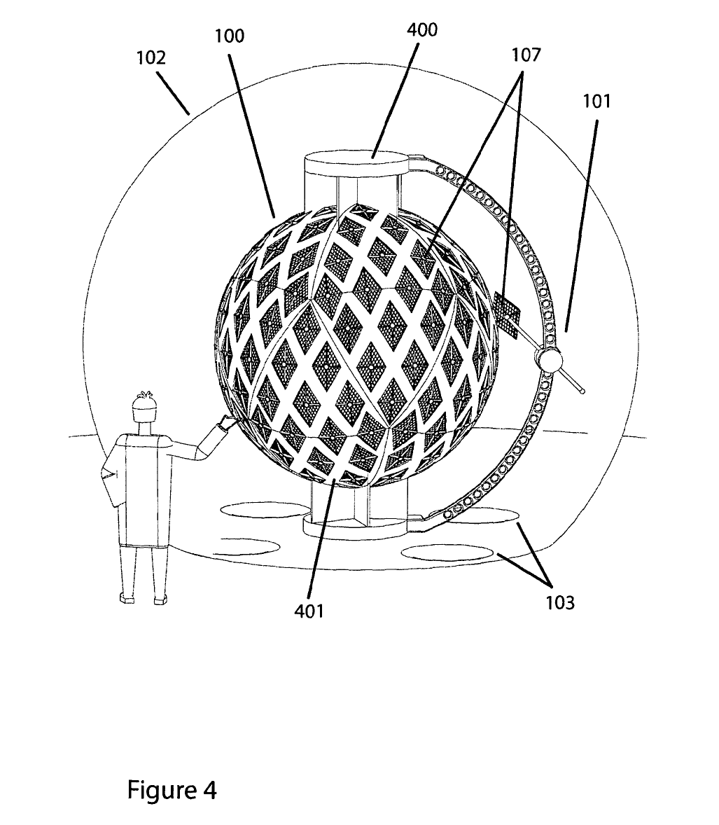

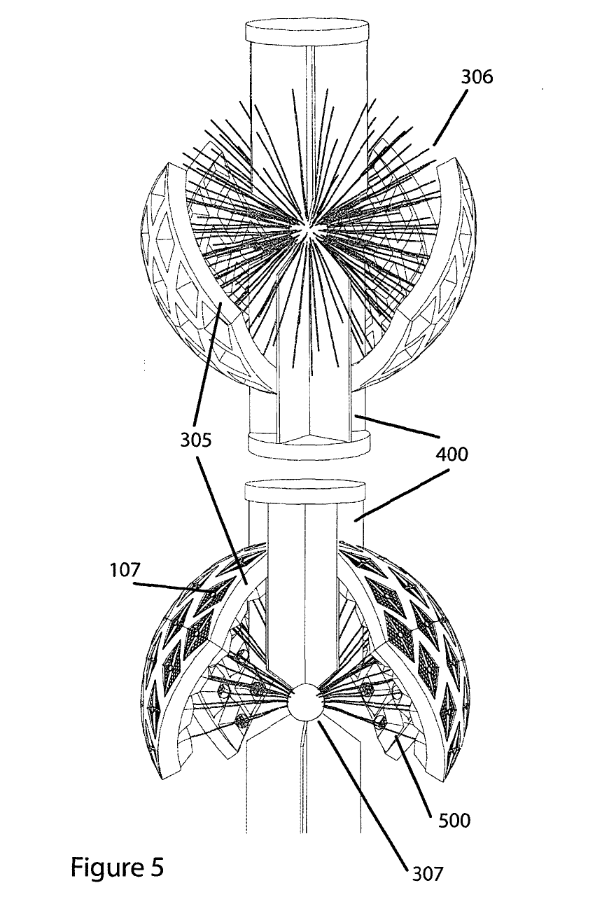

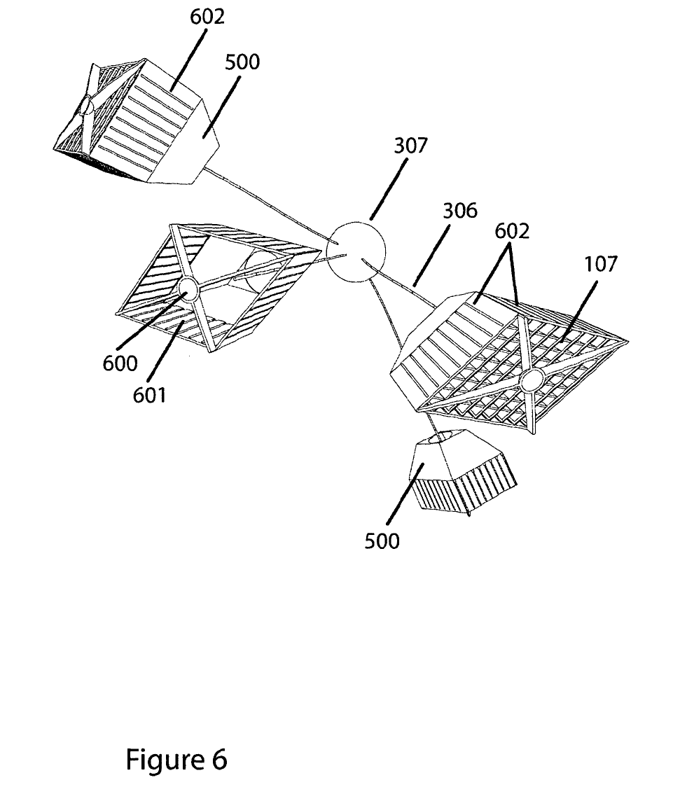

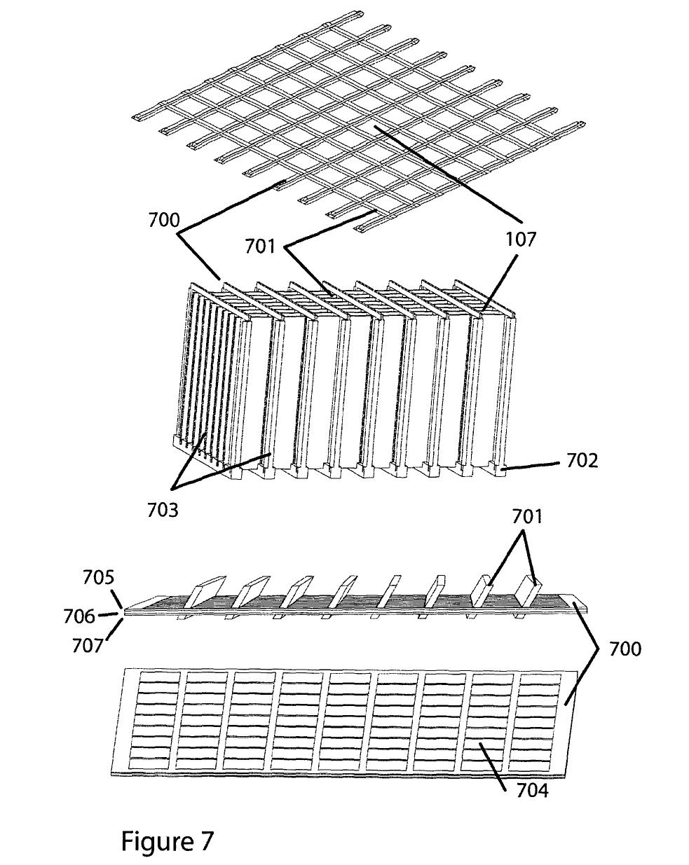

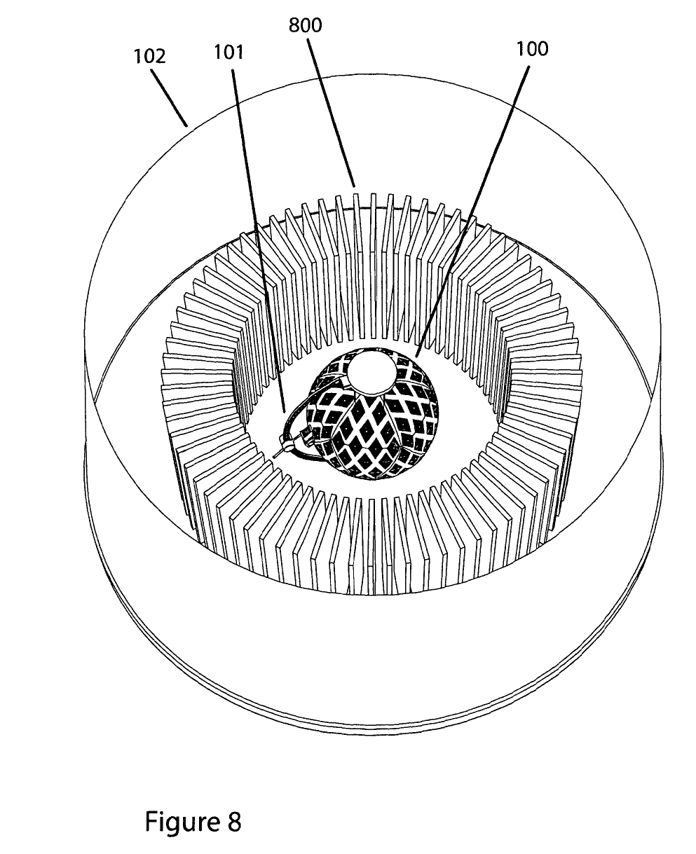

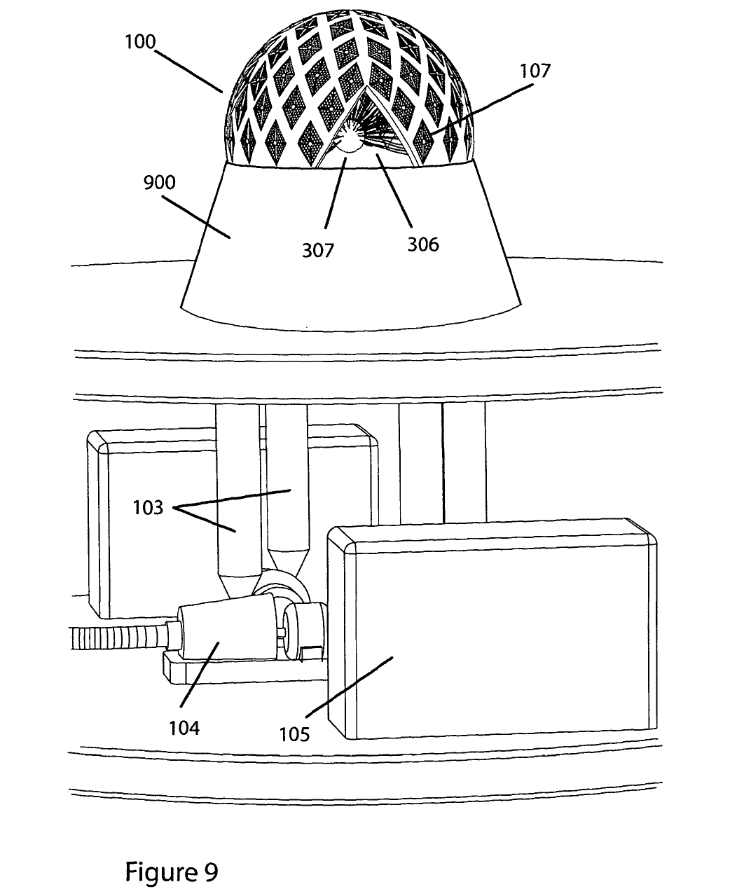

The geodesic frame, 401, houses one hundred and sixty processor clusters, 107, in this enlarged view from FIG. 1. The frame is supported on two columns, 400, and these columns conduct data communications, refrigerant, and power into the computer sphere, 100. A total of ten column segments are interdigitated with the ten frame segments.

In this instantiation a glass bubble, 102, forms a hermetic chamber or pressure vessel containing refrigerant gas. (While this spectacular, cartoon version aids explanation, it will be noted that such a vessel is probably neither the most practical nor efficient construction.) Ducts, 103, connect the chamber to the remaining elements of the refrigeration system. A multi-axis robot, 101, shown gripping a processor cluster, provides a means of assembly and repair.

FIG. 5: Geode cross sections showing central clock and communication distribution.

Two cut-away views show support columns, 400, the frame, 305, with and without processor clusters, and one hundred and sixty equal length radial connections, 306, to the centroid, 307. The radial connections can broadcast highly accurate clock or timing information synchronously to all processors.

The cage bottom, 500, seen extending into the frame's interior is part of the housing for processor clusters, 107, which form a pluggable, interchangeable module.

FIG. 6: Perspective view and detailed arrangement of processor clusters, cages and connectors.

A stripped away perspective view reveals the arrangement of processor clusters, 107, in their housings or cages, 601, around the centroid, 307, and its radial communication links, 306. A structure, 600, provides a graspable handle for manipulation by the robot. Multiple connectors, 602, are a conduit for data, power and refrigerant on each surrounding edge of the processor cluster and protrude through the holes in the cage, 601.

The bottom of the cage, 500, may house ancillary support functions such as power supply, test and management, and communications units.

FIG. 7: Processor cluster deconstruction with illustration of wafer stack, connectors and cooling surfaces.

Processor clusters, 107, are formed by stacking multiple, similar planar subunits, 700. These planes, for instance circuit cards or silicon wafers containing an array of processor units, 704, are connected into a trellis arrangement by spacers, 701. The trellis or waffle structure is largely hollow to allow unrestricted flow of refrigerant vapour away from the heat sources' evaporation zones. The spacers provide data interconnect between layers plus distribution of power and refrigerant via bus bars, 702, at the base. The routing of power, signals, and cooling liquid shares generally the same path hierarchy from supports, through geode frame, connectors, bus bars, spacers, and finally to wafers.

For cooling, the array of processors, 704, is maintained wetted with liquid-phase refrigerant via porous layers bonded to their surface. Spacers, 701, distribute refrigerant into these layers using a network of ducts and finally capillary action.

Connectors, 703, at the end of each plane and spacer row provide data channels between processor clusters, and can be used to effect various mesh topologies or 3-dimensional lattice interconnect schemes.

To gain nearly double the packing density, each plane may be constructed with back-to-back processor wafers, 705 and 707, and these may sandwich one or more further layers, 706. The sandwiched layers may contain, for instance, high-density DRAM memory.

FIG. 8: Computer system integrating heat exchangers within a single pressure vessel and without refrigerant compressors.

Heat exchangers, 800, placed directly around the computer geode, 100, and within the same pressure vessel, 102, are used to condense refrigerant without using compressors. The heat exchangers can have a far larger surface area than that of evaporation and will dump heat into ambient air or cold water from a river or lake for example. Within well designed operating parameters, the geode is maintained only a little warmer than the exit temperature of the cooling fluid, and the only energy expended by cooling system is in pumping the working liquids. Enough room around the geode is left for movement of the robot, 101.

FIG. 9: Hemispherically folded geode working in ambient conditions with interior refrigerant containment.

In this alternate form, the geode's, spherical topology is folded into a near hemispherical arrangement, 100. Supports of the other instantiations are replaced by a large vapour exit duct, 900, connected to compressors, 104, by piping, 103. Heat exchangers, 105, relay heat to ambient as before. Similarly, processor modules, 107, are connected with cabling, 306, to the centroid, 307, as shown in the cut-away of the drawing. For the case where rhomboid (as opposed to triangular) processing units are used in an icosahedral packing, it can be advantageous to use extra modules at the edge (more than exactly half than in previously described geodes—as depicted, 90 instead of 80). This allows the edge-around folding of signals to happen local to a module rather than awkwardly being routed between non-adjacent modules, so ruining interprocessor latency performance.

Normal ambient conditions can be used outside the geode (refrigerant is contained now on the inside), and humans rather than robots can do maintenance. Note that the processor modules must be capped on their outer surface, perfectly sealed around the edges, must endure a pressure differential, and some vapour lock mechanism needs to be included to facilitate removal and replacement. While this configuration has some advantages, it will be noted also that the cross-sectional area for egress of refrigerant vapour is substantially less than before—less than a quarter.

Where non-spherical interconnect is appropriate, a tubular form becomes a possibility. For example with the skirt, 900, replicated above and rectangular modules used instead of the rhombic ones for better packing. Conversely, in an isobaric refrigerant containment vessel (configured as in FIG. 1), and with refrigerant now additionally venting above and bellow, cooling performance can actually be improved over spherical versions.

It will be noted that with tubular or other open bodies, there are broader design choices for refrigerant vapour paths and containment volumes. This includes, ultimately, the ability to operate components in contact with the vapour containment vessel (rather than refrigerant), which is itself wetted with refrigerant and acts not unlike a giant heatpipe. In this configuration, radial signalling must cross the vessel's wall, whereas concentric signalling may or may no pass through those walls depending on layout. One possibility is to have capped pipes in the waffles' interstitial gaps, with these forming a manifold at the processor module's base. Such a manifold is ducted to—or forms part of—the pressure vessel.

### DETAILED DESCRIPTION OF PREFERRED EMBODIMENTS

As is well known, spherical surfaces may be approximated by triangulation based on subdivisions of platonic solids as depicted in FIG. 2. Both triangular and square faces can be recursively subdivided through edge bisection to yield similar each time quadrupling the number of polygons (note this is not true of the dodecahedron). Projection onto the sphere yields irregular or distorted results (not all facets are exactly the same size and shape). Although for engineers the cube is perhaps the most conceptually familiar and mechanically straightforward of all five platonic solids, the icosahedron as basis for a geode yields significantly lower grid distortion.

The icosahedral instantiation of the preferred embodiment will be appreciated by those skilled in the art as an example of many possible tessellations or tilings on the sphere. Alternate arrangements might also utilise further packing symmetries to advantage. For instance, a hemispherical version could be made where one half of the sphere is collapsed or folded onto the other side of the shell. Such an arrangement can improve access, extend the area available for interconnect, and in some cases allow further compression of the machine's radius. In applications other than climate science where spherical topology is not required, a ring- or tube-style physical arrangement may be used that supports toroidal interconnect topologies and others. Notionally this may be the equivalent of removing top and bottom icosahedral “caps” leaving 10 faces as a continuous band. However, rectilinear layouts would typically be preferred for annular processor arrangements.

In FIG. 1, the circumference of the geode is approximately three metres, a size representative of a large system in silicon-based semiconductor technology. Two generations of icosahedral subdivision yield 20 times 16, or 320 triangles. These triangles are paired to form 160 rhombic units, FIG. 3, in order to support identical quadrilateral subcomponents. It will be appreciated that using identical building blocks has advantage for design and manufacture.

Identical, interchangeable rhombic modules are shown in a rather naïve, suboptimal packing to emphasise grid distortion and unevenness of inter-module distances. Several methods would improve the packing in order to shorten worse-case signal paths. The illustrated module, 107, has parallel sides, however a tapered quadrilateral prism can be found to pack more closely. Greater subdivision depths also improve matters, allowing dispersal of irregularity across a larger number of interstitial gaps. Greater subdivision depths and smaller modules also provide finer granularity and better scalability. Viable systems may be assembled from one, two (tetrahedral), four (octahedron), six (cube), or more of these same modules, still with small (10's of centimetres) but considerably increased gaps.

Many processor technologies have been developed and the present invention is essentially agnostic as to processor genre. However, it is well known that hugely parallel problems are often better solved by simpler, lower-power processors and that this places additional burden on inter-processor communication—indeed, where the present invention excels.

Modules in the preferred embodiment, as depicted in FIGS. 6 and 7, are made from a stack of processor wafers, 107. In the preferred embodiment the wafers, 700, are of un-diced silicon wafers, but may be any other suitable technology such as circuit boards or ceramic hybrid circuits. Each wafer would contain many interconnected processors, 704. The stacking and folding of active surfaces allows for a very much more compact geode. In this example the geode's 25 square metre surface area is extended by a factor of approximately 20× to over 500 square metres. This represents ten to a hundred times the silicon surface area of current massively parallel supercomputers in one hundredth of the floor space.

The majority of the module is hollow which allows the passage and venting of refrigerant vapour into the pressure vessel, 102. The stacking distance is minimized for greatest density, but constrained in the limit by viscous and sonic effects of vapour flow. There is clearly a trade off between packing density and effective fluid flow, and depth of the module is a major factor in this also. A deeper module implies a smaller geode radius for the same active area. It will be noted that the overwhelming majority of the geode volume in FIG. 5 is empty, presenting an opportunity for further compaction providing power dissipation limits are not breached.

In the module's wafer stack, a number of spacers, 701, connect one layer or wafer to the next. Again, this would typically bridge many thousands of signals across the gap using arrayed connection points. Power and refrigerant supply through these pillars via bus bars, 702, or other delivery conduits also feed the wafers. Other additional active functions may be included on spacers such as random access memory or circuit switching for redundancy support.

Data errors and circuit defects are not uncommon in large computer systems and redundancy, reconfiguration and forward error correction would need to be implemented. To this end, nine wafers are shown, 700, giving one spare column per module. Within the wafers themselves, additional switching and routing would provide reconfiguration around defective processors. Such routing could also be instrumental in providing flexibility in the local connection topology without negative impact on signal transit times since distances would be on the scale of millimetres. Local mesh interconnect including isometric, square, hexagonal may be implemented, and this layered into 2D spherical mesh and 3D shell lattice. The hexagon-pentagon prismatic tiling detailed in the a previous reference requires an addition processing node at each vertex (20 pentagons) and this extra processor may be drawn from the pool of redundant, spare processors in any of the 5 modules abutting these corner locations.

The largely empty centre of the geode provides opportunity to site ancillary functions there. A cavity at the back of the module, 500, may for example house communications and power supply units. The preferred embodiment may well consume millions of amps of electrical current which would likely be impractical to deliver via the supports, 400. Instead a higher voltage is supplied through the supports and shell, 305, and down-converted locally. Furthermore, selected groups of processors may run at slightly different voltages in order to satisfy processing speed or a common clock rate. A multitude of local power supplies would conveniently provide that function and also afford redundancy in the power supply system. In the same cavity, communication switches could provide an aggregation function to and from optical fibre bundles, 306, for the multitude of IO and radial communication signals fed to the wafer stack. Clock distribution amongst the wafers from this area would also be convenient with equalisation of distance achieved through matched-length, slightly meandering paths or other means of delay control. Given the exquisite tolerances of modern manufacturing techniques, the timing skew of radial signals to every part of the geode could thus be kept within picoseconds.

Supports, 400, act as conduits for data, power and refrigerant in addition to mechanical attachment and stability. As drawn in FIG. 5, they easily house thousands of cables for 10 that have a total cross-section of perhaps a few square centimetres. If more bulk were need to carry power or refrigerant, supports may be elongated or additional leaves added. For instance, a further ten supports are conveniently added between the zigzag edges of the hemi-geodes depicted in FIG. 5. This may effectively divide the chamber in two sections and require two robots rather than one. The supports are configured geometrically on radial sections and as such neither present significant impediment to vapour flow nor interfere with radial cables, 306.

Variants of the preferred embodiment include systems with more than one concentric shell and chamber, with each such onion layer possibly having separate cooling regimes. A cryogenic centre chamber might house superconducting computing elements and subsequent layers accommodate semiconductor memory circuits and mass storage, so implementing efficient bandwidth/speed/memory hierarchies.

Concentric mesh/lattice, inter-module communications is via connectors, FIG. 6-602, individually sporting thousands of connections or channels, and hence millions of inter-module signals for the whole geode. Intra-module interconnect density would generally be orders of magnitude higher still, yielding many billions of signal channels total each with gigabytes per second bandwidth—prospectively an unprecedented zettabytes per second performance level. Any effective communication technique may be used including wired, capacitive, optical or radio, though given the short, direct paths involved, electrical signalling is probably indicated for electronic computers. The support framework, FIG. 5-305, provides adaptation between one module's connector and its corresponding pair on an adjacent module over the somewhat irregular gaps. This adapter may use, for instance, a passive multi-layer flexible printed circuit, fibre optic cables with coupling lenses, or simple mirrors to redirect free-space light beams. Active switching circuitry may also be included there. The path length can be made equal for all such connections using meanders on shorter paths. The illustrated preferred embodiment has worse-case distances of just a few centimetres corresponding to sub-nanosecond transit latencies. The sub-nanosecond nearest-neighbour latency remains constant with scaling of processor numbers and geode radius, providing packing distances are maintained.

Radial communication within the geode may take many forms and functions, granting flexibility and longer-range speed that a multi-hop mesh lacks. With a distance through the centre of three metres from any module to any module, a consistent transit latency of around 15 nanoseconds can be achieved (over optical fibre, 10 ns for free space). It is reasonable to expect that non-blocking packet communication can be realised in around a 20-nanosecond end-to-end, processor-to-processor in this size geode. This latency number scales with radius, as the square-root or cube-root of number of processors (ignoring switch complexity or other factors) depending on whether the ultimate limitation is a surface area (e.g. cooling) or a volume constraint.

Broadcast from the centroid can effect data and instructions transmission for SIMD style operations, search criteria broadcast (for associative, content addressable operations), and so forth, with the centroid holding program and sequencer. Feedback in the opposite direction from the geode for conditional execution or branching can be received within 20 nanoseconds from instruction issue. Reduction operations can use the radial communication mode to great advantage: global summation, combinatorial logic, priority trees, and so forth can similarly be resolved within a small fraction of a microsecond. A giant content-addressable or associative memory system could be implemented for search engines or database applications, again with sub microsecond response time.

Given the very tight synchronization possible over the entire geode, time division multiplexing can be effectively implemented in a globally scheduled, cooperative manner. Fixed link traffic or statically scheduled connections can be mixed with non-deterministic traffic over the same physical layer by assigning timeslots for each. Indeed, any combination of parallel (space division), time division, wavelength division, packet switched, dynamic or static routing can be implemented and all benefit from low-level synchronous, deterministic operation.

Combinations of radial and concentric packet transmission may be used to optimise overall communication bandwidth and latency. Mesh communications may be most effective for a certain radius, or number of hops, around any particular processor node; longer paths better serviced by the radial, packet switched network.

Free-space communication, such as using collimated laser beams, from the modules or centroid through the pressure chamber are also a viable communication medium. Such communications can effect internal and external (IO) links. Free-space routing is faster by approximately thirty percent than transmission over electrical or optical fibre cables.

Physical paths other than through the centroid are evidently available for communications. Any geometric chord between processors or modules could be chosen, and free-space optical switching could in principle connect modules and processors in a great variety of ways, including using physically switched elements (orientable mirrors, prisms) for directing signals. The supports, 400, could be perforated appropriately to allow such signals passage.

Physically, the centroid is less accessible than the modules on the outside of the geode. For this reason it is beneficial in terms of uptime to make it simple and highly reliable. Distributed traffic switching and scheduling circuitry based predominantly within the readily interchangeable modules would therefore be advantageous, possibly with robust, passive optical hubs placed at the centroid. Such hubs may, for instance, use optical filters to direct wavelength-coded data from frequency agile laser transmitters in the module bases.

Pulsed, frequency or amplitude modulated laser sources are well suited for radial communications, given the extraordinary accuracy and bandwidth of optical processing relative to electronic signalling. The increasing variety and availability of optical components, including nonlinear devices such as amplifiers, switches and logic elements, will allow many signalling functions to be implemented in the centroid and in the optical domain. At a more basic level, ultra-wideband femto-second pulses for clocks, multiphase clocks, or complex realtime reference or framing signals can also be implemented. Such reference signals generally have no latency constraint and so may be produced external to the pressure chamber, conducted through to the centroid and amplified there for distribution.

It will be noted that the quoted performance numbers pertain to a preferred embodiment with circumference of three metres and that other implementations at smaller scales will improve on those figures. For instance, it is quite feasible that molecular scale computing structures will be built that are many times more compact than semiconductor technology—with geode radius possibly in the centimetre or even millimetre range.

The geode contains potentially hundreds of square metres of high-power circuits perhaps dissipating hundreds of megawatts total. As demonstrated by existing heatpipe technology, evaporative, phase-change cooling can support 1 to over 100 megawatts per square metre and is therefore well suited to the cooling task. The refrigerant type is selected according to operating temperature, vapour pressure containment constraints, materials compatibility, safety, and peak heat flux density. The gamut includes methanol, ammonia, butane, or nitrogen or helium for cryogenic temperatures and so on. Water is a probable favourite for operation over 30° C., not least for its aesthetic parallel with the hydrological cycle.

The evaporation layer consists of a mesh, porous sintered metal sponge (or similar) in contact with the active circuits and constitutes a thin additional layer over the wafer and processors, FIG. 7—704, adding little to the overall bulk. Providing operation is within design limits, the temperature differential between hot (wafers, circuits) and cold ends (cooling water, ambient air) can be maintained at a fraction of a degree. As a guide to attainable cooling performance, 0.002° C./W for a pencil-size heatpipes has been reported in the literature. Nanoparticles, carbon nanotubes or other enhancements may further enhance nucleation and liquid phase conduction and further lower effective thermal resistance. Unlike conventional heatpipe loops however, the preferred embodiment relies on actively pumped fluid return, where capillary action is used only over the last few millimetres of liquid travel, and better performance yet may be achieved. Sufficient wetting is vital to proper operation and this is achieved with pumped fluid delivery via its tree distribution network. This may be complemented by a tree of drain ducts and suction pumps to remove any excess liquid that could be detrimental if accumulation occurs. Efficiency of this arrangement, then, rests mainly on the evaporative surface properties, viscosity in vapour transport ducts (waffle trellis), and sonic limits of the vapour. Heat flux at the many-megawatt level requires 10s of litres of refrigerant per second and cubic metres per second of water coolant as a thermal sink—well within practical limits.

Cooling fluids of the cold sink may include but are not limited to sea, lake or river water, and atmospheric air.

In FIG. 8, the cold-end heat exchanger, 800, may use such heat sinks directly at one side with refrigerant vapour on the other. Here, no compressors are used or power consumed to run them. The prime advantage in this configuration over conventional forced-air cooling or liquid cooling comes from extricating the bulk of a massive (efficient) heat exchange system, and being able to place it outside a very compact computing core, while maintaining a very low temperature gradient. It is not unreasonable to expect semiconductor junction temperatures to be maintained under 20° C. with ambient sink outlet temperature of 10° C. or lower.

Power consumption of integrated circuits can be significantly reduced by lowering operating junction temperature and thereby enabling supply voltage and leakage currents reductions. Power dissipation is generally very uneven with hotspots at locations where processing and dataflow are concentrated. Evaporative cooling provides a method to level or equalise temperatures since the liquid-phase refrigerant temperature is determined by its equilibrium with vapour at a specific pressure. The large hollows and interconnected spaces of the geode arrangement provide not only open areas for vapour diffusion and transport away from hotspots, but also large volumes to buffer transient flows. The outer shell of the geode allows passage of vapour from the back of modules and from the centroid thus allowing virtually any device anywhere in the pressure chamber (the system) to be cooled near isothermally. Indeed, cooler parts will be warmed by vapour condensation. For synchronous communications including the radial signals, thermal stability and predictability can eliminate propagation disparities and timing errors.

Modules can be manufactured and assembled in clean-room conditions and maintained throughout their operational life in a strictly controlled environment—that is never experience temperature or mechanical shock, or contamination. This places fewer constraints on their design and implementation; conventional hermetic packaging or certain passivation layers may be obviated for example. Most importantly thermal expansion stresses between dissimilar materials (a common source of semiconductor chip failure) can largely be avoided. Any leaked or out-gassed contaminants would be scrubbed from refrigerant gasses to avoid deleterious affects on cooling system efficiency or chemistry.

Where a negative temperature gradient is required between the system and ambient (e.g. sub-zero or cryogenic), compressors can be used in a classic heat-pump refrigeration loop, FIG. 1. The pressure vessel, FIG. 1—102, may experience excess pressure or partial vacuum dependant on refrigerant type and operating point, and would normally be of a robust, conservative design. A refrigerant operating near atmospheric pressure diminishes pressure vessel's technical requirements and costs. In FIG. 1 the compressors are placed on a floor below the geode. However, multiple compressors surrounding the computer in a geodesic arrangement would probably be more effective if less aesthetic. A temperature regulation system would control compressor and fluid pumps speeds in a servo-loop with in-module sensors and electronic power supply loading data.

A multi axis robot, 101, can swap out defective modules and do so with a mean-time-to-repair of potentially a fraction of a second. Modules are exchanged through an air lock (not shown) using further automated handling systems. A number of modules can be warehoused within the pressure chamber, 102, at operating temperature and ready for immediate deployment. The robot, holding substitutes, can be positioned so as not to obstruct any free-space optical communication paths during normal operation.

1) A parallel computer comprising a geodesic physical framework of closely packed processing subunits, distributed communications infrastructure and support functions.

2) A computer according to claim 1 where the geode is formed by triangulated subdivision of a platonic solid, particularly the icosahedron, or another semi-regular polyhedra.

3) A computer according to claim 1 formed by recursive subdivision of a polyhedron with quadrilateral faces such as the cube.

4) A computer according to previous claims where the structure is closely spherical, with processors arranged at a substantially constant radius and consequently with closely matched signal propagation times to and from the geode centre or centroid.

5) A computer according to previous claims with topologically equivalent, but physically collapsed arrangement of processor modules wherein such folding presents two or more open surfaces for external connection, including a single folding yielding approximately a hemisphere, or repeated foldings yielding approximately spherical segments.

6) A processor arrangement according to claim 5 where such rearrangement allows redistribution or spreading of processor modules and thereby a reduction of geode radius compared to a like number of processors implemented in a complete sphere.

7) A computer geode according to previous claims where triangles are paired to form a rhombus as in FIG. 3, a parallelogram or more generally, a quadrilateral.

8) A computer according to previous claims where all modules or sets of modules are identical, and the varying interstitial gaps due the consequently irregular tessellation on the geode are accommodated by bridging signals over such gaps electronically, optically or by another communications means.

9) A computer according to claim 8 where module shape and packing is optimised to minimise worst-case separation distance or worst-case signal delay.

10) A computer according to previous claims with gyrencephalic organisation to increase surface area available to computing elements or active components comprising: segmented and folded facets occupying space in the radial direction; subunits forming a trellis or waffle packing structure of planar subunits or wafers within each module.

11) A module according to claim 10 comprising a generally prismatoid cage tapering towards the computer centre thus facilitating denser packing and reduced worst-case processor separation.

12) A module according to claim 10 where each subunit layer or wafer accommodates processors on two or more exposed surfaces, front and back sides, and optionally, multiple additional sandwiched layers.

13) A module according to claim 10 with pillars between wafers in the stack, wherein such pillars provide inter-module and intra-module communications interconnect, clock, power and refrigerant distribution, and may support ancillary functions such as memory and optical interfaces.

14) A module according to claim 13 with a matrix of bussing arrangements or bus bars providing hierarchical connection of pillars and wafers and inter-module edge connection ports.

15) A module according to claim 10 that incorporates ancillary functions that may or must be distributed around the geode: power supply functions, communication interfaces, clock distribution and equalisation circuits, refrigerant distribution and maintenance functions.

16) A module according to claim 10 wherein the module is largely hollow and open, thus permitting vapour transit within and through the module.

17) A computer according to previous claims with multiple concentric geode layers, each with possibly separate hermetic environments and cooling regimes, thereby supporting distinct processor technologies or functions.

18) A computer geode according to previous claims with physical support pillars or leaves attached on radially oriented planes at facet edges, thereby not impeding installation and extraction of processor modules, including such arrangements on icosahedral geodes with 5, 10, or 20 inter-facet support pillars.

19) Support pillars according to claim 18 containing conduits for power, signals, and refrigerant, thereby conducting these between external systems and the interior of the geode through an interdigitated arrangement with the concentric and radial routes of processor modules.

20) A computer as in previous claims wherein a high degree of signal synchronisation or temporal determinism is afforded by the spherical-shell packing of processing elements and the distribution of signals from the common centroid of all such elements.

21) A computer according to claim 20 where sequential processing steps or communication cycles are governed by a centralised time source or reference clock.

22) A computer according to claim 20 where clocks and signals paths are furled or meandered to equalize distance and signal delay in order to reach all processor elements at substantially similar instants in time or alternatively in a precise, phase-controlled sequence.

23) A computer according to previous claims wherein temporally deterministic communication channels implement static signal routing and/or static scheduling, thus permitting deterministic data and instruction transmission including SIMD-style processing, whereby such communications may be implemented without recourse to additional clocks, handshake or interlocks, and does not incur the performance penalties of clock domain boundary re-synchronization.

24) A computer according to previous claims wherein synchronous, constant-latency, one-to-all, many-to-one, many-to-many, and all-to-all communication is affected.

25) A multi-processor system implemented according to previous claims forming a two dimensional mesh network, multi-layer three-dimensional or higher dimensional lattice of interconnects between adjacent or neighbouring processing units.

26) A multi-processor network implemented according to claim 25 where the network topology is a geodesic spherical-shell mesh or lattice, including those based on triangulation, triangle-square packings, and hexagon-pentagon.

27) A multi-processor system implemented according to previous claims with low-latency, neighbour-to-neighbour, deterministic communication method afforded by globally synchronous clocking, fixed and isothermal operating temperature, and minimal transit distances.

28) A multi-processor system implemented according to previous claims forming a hub-and-spoke, radial network from the processors via a central unit or centroid.

29) A computer according to claim 28 where one or more SIMD instruction streams are broadcast from the centroid.

30) A system according to previous claims where communications utilise frequency division multiplexing, DWDM wave division multiplexing, in addition to time division and space division multiplexing, and where such communications are affected in one or more electromagnetic modalities: wired, wireless radio, fibre optic cable and free space optical transmission.

31) A system implemented according to previous claims that includes additional or alternate communication connections along non-radial and non-concentric routes such as chordic paths or other shortcuts.

32) A communications system according to claim 31 utilising the geode's central void for routing optical free-space signals, including with reconfigurable laser beams through systems of redirectable mirrors, lens and prisms.

33) A system according to previous claims where a central unit or centroid implements clock, timing reference, and data packet distribution and switching.

34) A system according to previous claims where a central processor or centroid unit implements global data reduction functions, global sum, min-max operations or other operations on radially converging signals.

35) A system according to previous claims where timing or data reference signals are produced outside the geode and are conducted through the centroid for distribution.

36) A phase-change, evaporative cooling loop method for the computers of previous claims comprising refrigerant-wetted power dissipating components, a refrigerant containment chamber housing said components, cold sink heat exchangers and vapour condensers, and ducting for return and distribution of liquid-phase refrigerant to wet said components.

37) A system according to claim 36 maintained effectively under isobaric, or within a thermodynamically non-compressible flow regime, wherein components are maintained at closely isothermal conditions.

38) A system according to previous claims in which all or large subsets of the computer core share the same atmosphere of a single hermetic pressure vessel.

39) A system according to claim 36 in which heat exchangers are incorporated directly within the hermetic pressure vessel.

40) A system according to claim 36 with surface coatings affecting a porous wicking layer for refrigerant liquid, implemented as a sintered metal sponge, metal mesh, grooves, or other physical structure and materials encouraging capillary action and refrigerant spreading.

41) A system according to claim 36 where refrigerant liquid is actively pumped, typically in slight excess, from the condensers.

42) A system according to previous claims with the addition of a vapour compressor or heatpump, such that a the pressure in the chamber may be actively and accurately maintained, or such that a negative temperature differential may be sustained between the heat dissipating components and heat sink or ambient cold end.

43) A system according to claim 36 wherein nano particles, carbon nano-tubes, or such additives are used to enhance cooling performance of the vapour loop system.

44) A method according to previous claims whereby processor modules may be assembled, transported, stored, and operated in a precisely constrained, predetermined environment, including within a controlled temperature range, pressure range, devoid of mechanical stresses or shocks, and in an atmosphere of known chemical composition.

45) A system according to previous claims in which one or more robots affect rapid and automatic component installation, replacement or maintenance.

46) A system according to claim 46 that includes an air lock or vapour lock, allowing passage of component modules into the operating chamber or pressure vessel without vapour loss or service interruption.

47) A system according to previous claims that includes a storage facility for spare modules with the pressure chamber.

48) A computer system according to previous claims with a modified processor topology, such as one forming a tube or torus or subset of the previously claimed instantiations.

49) A computer according to previous claims that rather than an enclosing chamber, has an interior refrigerant chamber with processing elements placed on and around a vessel forming that chamber, and atmospheric conditions prevailing external to the said chamber, whereby with the aid of vapour locks at each processor module, such units may be installed and removed readily by either human or robot operatives.
